(19) United States
(12) Patent Application Publication
(10) Pub. No.: US 2017/0349470 A1
(43) Pub. Date: Dec. 7, 2017

(54) METHOD FOR DEWATERING SLUDGE ASSISTED BY A FLOCCULATING REAGENT AND FACILITY FOR IMPLEMENTING SUCH A METHOD

(71) Applicant: Veolia Water Solutions & Technologies Support, Saint-Maurice (FR)

(72) Inventors: Cedric CRAMPON, Champingy-Sur-Marne (FR); Malik DJAFER, Boulogne-Billancour (FR); Eric GUIBELIN, Saponay (FR)

(73) Assignee: Veolia Water Solutions & Technologies Support, Saint-Maurice (FR)

(21) Appl. No.: 15/536,824

(22) PCT Filed: Dec. 18, 2015
(86) PCT No.: PCT/EP2015/080598

§ 371 Date: Jun. 16, 2017

(30) Foreign Application Priority Data
Dec. 19, 2014 (FR) 1462915

(51) Int. Cl. C02F 11/14; C02F 1/34; C02F 1/52; C02F 11/12; C02F 1/54; C02F 9/00

(52) U.S. Cl. CPC C02F 11/14; C02F 11/127; C02F 1/54; C02F 1/34; C02F 1/5236; C02F 9/00

(57) ABSTRACT

Method for dewatering sludge assisted by flocculating reagent, said method comprising an injection of flocculating reagent into the sludge and a step for dewatering said sludge, characterized in that it comprises a preliminary step for mixing (4) said sludge so as to destructure it and reduce its viscosity. Installation for implementing this method.

### FIELD OF THE INVENTION

The field of the invention is that of the treatment of sludge with or without organic matter content. The invention relates especially to the treatment of sludge from purification stations that may or may not be mixed with other wastes, as well as that of sludge coming from the methods for the production of potable water or sludge coming from other industrial methods.

More specifically, the invention relates to a method for dewatering sludge, whatever its origin, implementing a method for the injection of flocculating reagent, such as a polymer, into this sludge. Such methods are herein called <<dewatering assisted by flocculating reagent>>.

Such a method finds application especially for dewatering sludge, possibly already thickened, having low dryness or dry solid content, in practice lower than 15% by mass (preferably 2% to 7% by mass. The term “dry solid content of sludge” is understood to mean the percentage by mass of dry matter that it contains. Indeed, sludge is a fluid formed by a mixture of mineral matter and water, and chemical residues when the sludge is of industrial origin, and, as the case may be, organic matter. The dry content of sludge is calculated by establishing the weight ratio between the mass of the dry matter and the total mass of the sludge.

This sludge can come especially from methods for water purification or methods for treating domestic or industrial effluents.

### PRIOR ART

Methods for treating water generate large volumes of sludge that are increasing with industrial and urban development.

Methods have been developed in recent decades to reduce the volumes of this sludge, among them especially methods for dewatering.

These methods of dewatering can be implemented by means of various types of equipment (centrifuges, drums, tables, tray filters, belt filters etc.) and use appropriate flocculating and/or coagulant reagents that promote the separation of the water from the rest of the sludge within the equipment in question.

The costs of implementing these methods of dewatering assisted by flocculating reagent are considerably impacted by their cost. In particular, certain types of sludge that are particularly difficult to dewater require heavy doses of flocculating reagent that increase the costs of the plant implementing such methods.

Differents methods have thus been proposed in the prior art to optimize the consumption of these flocculating reagents or to do away with the need to use them.

Thus, there is the Déhydris Lime® method from the Degrennont company. In this method lime is mixed with the sludge to be dewatered in a mixer and then conveyed to a centrifuge, into the spout of which the polymer is injected.

Such a technique has the drawback of requiring the input of an additive other than flocculating reagent, namely lime, and of thus increasing the mass of sludge. Any savings made on the quantities of polymer distributed are at least partially compensated for by the expenditure inherent in the addition of lime and the discharging of the additional volume of sludge.

There is also the known Déhydris Osmo® by the Degrennont firm, aimed at subjecting the sludge to a magnetic field so as to modify its zeta potential.

Such a method has the drawback of entailing the implementing of a magnetic field which is a complex technique to implement.

Also known is the FlocFormer method by the firm Aquen which implements two main steps. The first consists in injecting a polymer into a stirring chamber receiving the sludge. The second step consists in flocculating the mixture of sludge and polymer in a second, bulkier chamber with light stirring to form the flocs.

This technique has the drawback of involving high energy consumption related to the possibly large volume of the flocculation chamber. In addition, the device implementing such a method is independent of the dewatering plant. The device is designed to be upstream to this plant and must be managed independently of it.

We may also cite the SLG® method by the Orege firm which proposes to subject the sludge to a light flow of compressed air, of the order of 1 to 2 bars following which the mixture of sludge and compressed air is depressurized in order to facilitate subsequent dewatering. The polymer however is still injected into the spout of the centrifuge or even shifted by variable distances upstream to the centrifuge, in the sludge inlet pipe, as may be recommended by the prior art in certain situations.

Such a method has the drawback of being bulky and involving a set of costly elements that require maintenance such as, for example a compressor, a reactor or again a separator.

We might also cite the IHM (<<inline hydrodynamic mixer>>) mixer by EMO in which the polymer is injected upstream to the centrifuge. Then a turbulence is created by means of a valve in order to improve the sludge/polymer mixture. The energy needed to create the turbulence comes from the fluid itself and therefore from the supply pump of the centrifuge.

In addition to the fact that these methods of the prior art have to be implemented in bulky installations, it will also be noted that none of them has proved itself in terms of real savings in polymer except for the adding of lime. Nor has there been any significant gain in dry solid content, i.e. more than 1.5% of dry solid content.

### GOALS OF THE INVENTION

The goals of the invention are to propose a method for dewatering sludge, for equal consumption of flocculating reagent and quality of centrifugates, and/or to optimize the load of the dewatering machines such as the existing centrifuges and/or increase the rate of capture of the solid phase by the flocculating reagent.

It is also a goal of the present invention to describe a method of this kind that can easily get integrated into an existing method of dewatering without interfering with the method of dewatering.

It is also a goal of the present invention to propose a plant to implement such a method.

It is a goal of the present invention to disclose such a plant which, in at least certain embodiments, can integrate existing dewatering machines in order to optimize their working.

In particular, it is a goal of the present invention to disclose such a plant that optimizes the working of centrifuges already in place to dewater sludge.

It is also a goal of the present invention to describe a plant such as this that can be very easily set up without any need to dismantle or move or replace the dewatering equipment such as the centrifuge already in place.

### SUMMARY OF THE INVENTION

These goals, as well as others that shall appear here below are achieved through the invention which concerns a method for dewatering sludge assisted by flocculating reagent, said method comprising an injection of flocculating reagent into the sludge and a step for dewatering said sludge, characterized in that it comprises a step, prior to said step of dewatering, for mixing said sludge so as to destructure it and reduce its viscosity.

The invention therefore proposes a method that is simple to implement, aimed at subjecting the sludge to be dewatered to a preliminary step of physical treatment comprising a mixing that destructures the sludge and reduces its viscosity. This step has indeed proved to be efficient in increasing the affinity of the sludge for the flocculating reagent and, as a corollary, increasing the efficiency of the flocculating agent within the dewatering apparatus. This step also makes the biggest and/or the heaviest particles present in the sludge finer and potentially releases more water bound to these particles. Such an increase in efficiency either brings a gain in dry solid content points at the exit from the dewatering apparatus for equal consumption of flocculating reagent or appreciably reduce the doses of flocculating reagent that have to be used to obtain a given dry solid content for this sludge, or increases the efficiency of capture of organic matter by the flocculating reagent, or again increases the load of the dewatering apparatus In any case, the invention provides for major savings in the operating costs of such machines and the costs of discharging sludge.

Advantageously, said preliminary step for mixing said sludge comprises the introduction of this sludge into a mixer comprising a cylindrical chamber provided with blades mounted rotationally on a shaft rotating at a speed of rotation of 5 rpm to 4000 rpm, preferably from 1000 rpm to 2000 rpm. Such mixing speeds further optimize the goal sought, namely the increasing of the efficiency of the flocculating reagent.

Preferably, said step of dewatering is a centrifugation step implemented by means of at least one centrifuge. Centrifuges are commonly used to dewater sludge. A centrifuge is a costly piece of equipment, the price of which varies greatly according to size and performance. The method according to the invention therefore offers an economically interesting alternative to replacing equipment that performs less well (and is older) by equipment that performs better (and is more recent).

According to one variant of the invention, said injection of polymer is done into the spout of said centrifuge. The “spout” of the centrifuge is the point at which the material to be centrifuged enters it.

However, according to one particularly interesting variant, said step for injecting flocculating reagent is done by injecting said polymer during or upstream to said preliminary step. Such a step makes it possible to further optimize efficiency of the flocculating reagent and therefore the performance of the dewatering apparatus. According to such a variant, the flocculating reagent is mixed with the de-structured sludge to give an intimate mixture in which the flocculating reagent has its function optimized.

According to one variant of the invention, the method further comprises an injection of additive, especially a coagulant such as ferrous chloride, in said sludge during or upstream to said preliminary step. Such a step further optimizes the action of the flocculating reagent on the sludge.

According to one variant of the invention, the method comprises the injection of hot water and/or live steam or flash steam and/or condensates (such condensates could be derived from other methods and be available on site) during or upstream to said preliminary step, in order to pre-heat said sludge. Such a pre-heating step further reduces the viscosity of the sludge and further optimizes its dewatering while at the same time optimizing the consumption of flocculating reagent.

According to one variant of the invention, the method additionally comprises an injection of dilution water into said sludge during or upstream to said preliminary step. Such a step dilutes the sludge so as to further optimize the contact between the flocculating reagent and the sludge.

Equally, according to one variant of the invention, the method comprises an aeration of said sludge during or upstream to said preliminary step. This step also enables the flocculating reagent to interact better with the sludge in forming a sludge/polymer/air emulsion in the chamber of the mixer.

All these fluids are mixed at high speed in the chamber of the mixer, the dimensions of which are computed accordingly.

The invention also relates to a plant for implementing the method according to the invention comprising an apparatus for the dewatering of sludge and means for injecting flocculating reagent, characterized in that it includes a mixer provided upstream to said dewatering apparatus. Such a mixer can easily be integrated into an already existing plant including said dewatering apparatus to make the performance of this equipment more dynamic.

Advantageously, said mixer comprises a cylindrical chamber provided with rotationally mounted blades. Such mixers are commercially available. The sole purpose of the blades is to mix the sludge. They play no part in making the sludge move forward in the chamber. The cylindrical chamber has a small volume and the residence time in the chamber is very short, of the order of some seconds.

Again, advantageously said dewatering apparatus is a centrifuge.

Preferably said mixer is connected to means for injecting flocculating reagent such as a polymer.

According to one variant, said mixer is connected to means for injecting organic or inorganic coagulant such as ferrous chloride.

According to one variant, said mixer is connected to means for injecting dilution water.

Also, according to one variant, said mixer is connected to means for injecting hot water and/or live steam and/or flash steam and/or condensates to preheat the sludge.

Also, according to one variant, said mixer is connected to means for injecting compressed air.

In this case, the plant preferably includes a degassing chamber provided between said dynamic mixer and said dewatering apparatus.

### LIST OF FIGURES

The invention, as well as its different advantages will be understood more easily from the following description of an embodiment, given purely by way of a non-exhaustive illustration and with reference to the figures, of which:

FIG. 1 is a schematic representation of a plant according to the present invention;

FIG. 2 is a graph indicating consumption values for flocculating reagent (polymer) during the implementation of the plant according to FIG. 1 using the method according to the invention on the one hand and a classic prior art method on the other hand.

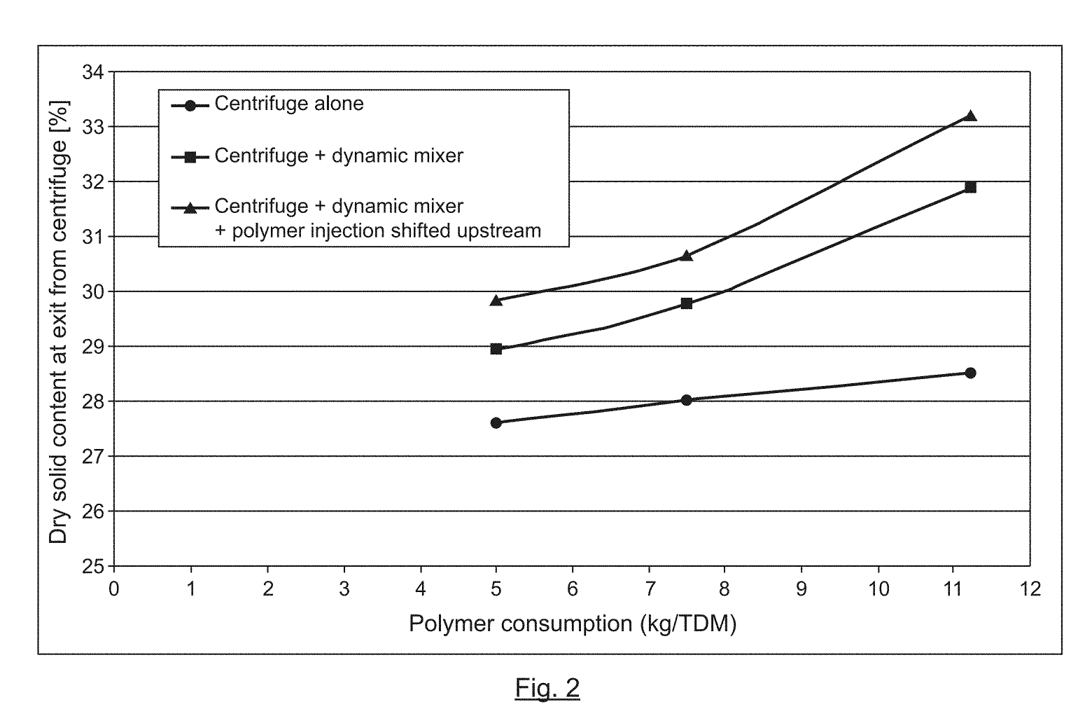

### DESCRIPTION OF EMBODIMENTS OF THE INVENTION

Plant

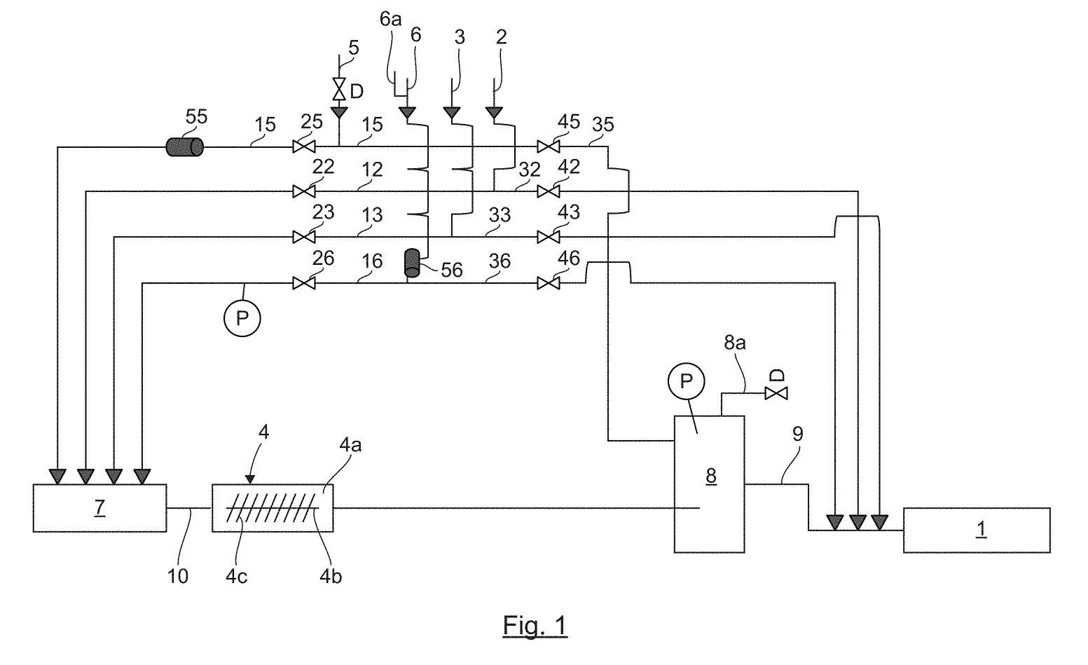

Referring to FIG. 1, the plant comprises a sludge-dewatering apparatus constituted by a centrifuge (Andritz®, model D2L). This centrifuge is connected to sludge-feed means 2 and polymer-injecting means 3.

In accordance with the present invention the plant also has a mixer 4 provided upstream to said dewatering apparatus provided with means for the injection of compressed air 5,d e, water-feed means 6, and means 6a for injecting ferrous chloride.

The sludge-feed means 2, the polymer-injection means 3, the compressed air injection means 5 and the water-feed means are connected by pipes, respectively 12, 13, 15, 16 to a collector 7. Valves 22, 23, 25, 26 enable the distribution, respectively, of the sludge, polymer, compressed air and water within it. The pipe 15 for feeding compressed air to the collector 7 is equipped with a flowmeter 55.

The sludge-feed means 2, the polymer-injection means 3, and the water-feed means are connected by pipes, respectively 32, 33, 36 to the centrifuge 1. Valves 42, 43, 46 enable the distribution, respectively, of the sludge, polymer and water directly to its spout.

The pipes 16 and 56 for conveying water respectively to the collector 7 and to the centrifuge are each equipped with a flowmeter 56.

The compressed-air injection means 5 for their part are connected by a pipe 35 to a degassing chamber 8, equipped with a vent 8a, a valve 45 enabling the distribution of this compressed air to this vent. This degassing chamber is connected to the spout of the centrifuge 1 by a pipe 9.

In accordance with the present invention, the mixer 4 comprises a cylindrical chamber 4a equipped with a rotating shaft 4b on which there are mounted blades 4c. The rotating shaft is moved by a motor (not shown in FIG. 1) which enables the blades to be driven at a high rotating speed of 500 rpm to 4000 rpm.

The mixer 4 receives sludge, polymer, ferrous chloride, water and compressed air coming from the collector 7 via a common pipe. The mixed sludge is conveyed towards the degassing chamber 8 by a pipe 11.

The plant described here enables water, polymer and compressed air to be conveyed to the collector 7 and/or towards the centrifuge.

Method

The plant described here has been implemented to dewater the mixed sludge digested according to the prior art on the one hand and according to the invention on the other hand. This sludge has an initial dry solid content of 28%.

In the context of these experiments, the centrifuge has always been used at its maximum capacity (2000 G).

In a first experimental phase, the valves 22, 23, 25, 26, 45, 46 were closed and only the valves 42 and 43 were opened so as to direct the sludge and the polymer coming from the feeding means 2 and 3 for these constituents directly to the spout of the centrifuge 1, without travelling through the mixer according to the prior art.

In a second experimental phase according to the invention, the valves 23, 25, 26, 45, 46 were kept closed. The valve 22 was opened to authorize the distribution of the sludge in the mixer 4 via the collector 7 and the valve 42 was closed. The valve 43 was kept open to continue to convey the polymer to the spout of the centrifuge 1.

In a third experimental phase, the valves 25, 26, 35, 46 was kept closed. The valve 22 was kept open, the valve 43 was closed and the valve 23 was opened to permit, according to the invention, the conveyance of the sludge and polymer to the mixer 4.

During each of these three experimental phases, the polymer was used in three different doses, i.e. 5 kg/TDM (tonnes of dry matter), 7.5 kg/TDM et 11 kg/TDM. The mixer was used for the second and third experimental phases with a blade speed of 2000 rpm enabling the sludge to be destructured before it was conveyed to the centrifuge 1 via the degassing chamber 8.

Since the sludge does not need it, no ferrous chloride was added.

The results of dry solid content values for the sludge at exit from the centrifuge 1 are summarized in the graph shown in FIG. 3.

These results show that, with the same polymer dose, it is possible through the invention to obtain a dry solid content for the sludge that is far better with the invention, especially when the injection of polymer is done in the collector provided upstream to the dynamic mixer.

Thus, for a polymer dose of 11.3 kilograms per tonne of dry matter (TDM), through the invention, a dry matter content for sludge of 32%, and even more than 33% was obtained by injecting polymer upstream to the dynamic mixer, whereas the dry matter content obtained in the prior art was only 28.5%. This was obtained without any addition of ferrous chloride and compressed air because the sludge does not need it. A comparable dry matter content of 29% was obtained by implementing polymer at a rate of only 5 kg/TDM, giving savings of nearly 50% in quantity of polymer.

1-18. (canceled)

19. Method for dewatering sludges assisted by flocculating reagent, said method comprising an injection of flocculating reagent into the sludge and a step for dewatering said sludge, characterized in that it comprises a preliminary step prior to said step of dewatering, for mixing said sludge so as to destructure it and reduce its viscosity.

20. Method according to claim 19, characterized in that said preliminary step for mixing said sludge comprises the introduction of this sludge into a mixer comprising a cylindrical chamber provided with blades mounted rotationally on a shaft rotating at a speed of rotation of 500 rpm to 4000 rpm.

21. Method according to claim 19, characterized in that said speed of rotation ranges from 1000 rpm to 2000 rpm.

22. Method according to claim 19, characterized in that said step of dewatering is a step of centrifugation implemented with at least one centrifuge.

23. Method according to claim 19, characterized in that said step for injecting flocculating reagent is done by injecting said flocculating reagent during or upstream to said preliminary step.

24. Method according to claim 19, characterized in that the method comprises the injection of hot water and/or live steam or flash steam and/or condensates during or upstream to said preliminary step for pre-heating said sludge.

25. Method according to claim 19, characterized in that the method comprises an injection of dilution water into said sludge during or upstream to said preliminary step.

26. Method according claim 19, characterized in that the method comprises oxygenating said sludge during or upstream to said preliminary step.

27. Method according to claim 19, characterized in that the method comprises an injection of coagulant reagent into said sludge during or upstream to said preliminary step.

28. A method of dewatering sludge that destructures the sludge and reduces the viscosity of the sludge upstream of dewatering, the method comprising:
injecting a flocculating reagent into the sludge;
after injecting the flocculating reagent into the sludge, directing the sludge into a cylindrical mixer having a plurality of blades mounted on a shaft;
prior to the sludge being directed into the mixer, injecting water or steam into the sludge;
prior to the sludge being directed into the mixer, oxygenating the sludge by injecting compressed air into the sludge;
wherein the sludge in the cylindrical mixer is conditioned by the addition of the flocculating reagent, water or steam and the compressed air;
mixing the conditioned sludge in the cylindrical mixer by rotating the blades in the cylindrical mixer approximately 500-4000 rpm and in the process destructuring the sludge and reducing the viscosity of the sludge in the process; and
after mixing the sludge in the cylindrical mixer, directing the sludge to a dewatering device and dewatering the sludge.

29. The method of claim 28 wherein prior to directing the conditioned sludge to the cylindrical mixer, directing the conditioned sludge to a collector and thereafter directing the conditioned sludge from the collector to the cylindrical mixer; and wherein there is a degasser operatively interconnected between the cylindrical mixer and the dewatering device, and wherein the method includes directing the sludge from the cylindrical mixer to the degasser and degassing the sludge in the degasser and thereafter directing the sludge from the degasser to the dewatering device.

30. A dewatering system for dewatering sludge comprising:
a sludge inlet configured to receive sludge and direct the sludge into the dewatering system;
a flocculating reagent injection site forming a part of the dewatering system and configured to receive a flocculating reagent and to inject the flocculating reagent into the sludge;
a cylindrical dynamic mixer located downstream of said sludge inlet and said flocculating reagent injection site for receiving sludge and configured to destructure the sludge and reduce the viscosity of the sludge;
the cylindrical dynamic mixer including a shaft and a plurality of blades mounted on the shaft and wherein the blades are configured to rotate and engage the sludge;
upstream of the cylindrical dynamic mixer, the system includes a water or steam inlet for receiving water or steam and configured to mix the water or steam with the sludge prior to the sludge reaching the cylindrical dynamic mixer;
upstream of the cylindrical dynamic mixer, the system includes a compressed air inlet for recovering compressed air and configured to inject the pressed air into the system where it is mixed with the sludge prior to the sludge reaching the cylindrical dynamic mixer;
a dewatering device located downstream of the cylindrical dynamic mixer and configured to dewater the sludge after the sludge has been mixed and destructured in the cylindrical dynamic mixer; and
a degasser operatively interconnected between the cylindrical dynamic mixer and the dewatering device for receiving sludge from the cylindrical dynamic mixer and wherein the degasser is configured to degas the sludge prior to the sludge being directed to the dewatering device.
